(19) United States
(12) Patent Application Publication
(10) Pub. No.: US 2018/0114384 A1
(43) Pub. Date: Apr. 26, 2018

(54) CLOUD-BASED KEYLESS ACCESS CONTROL SYSTEM FOR HOUSING FACILITIES

(71) Applicant: Visible Energy, Inc., Palo Alto, CA (US)

(72) Inventor: Marco Emilio Graziano, Palo Alto, CA (US)

(73) Assignee: Visible Energy, Inc., Palo Alto, CA (US)

(21) Appl. No.: 15/334,096

(22) Filed: Oct. 25, 2016

(51) Int. Cl. G07C 9/00; H04L 29/08

(52) U.S. Cl. CPC G07C 9/0069; G07C 9/00103; H04L 67/10

(57) ABSTRACT

A cloud-based system that include a plurality of door control assembly equipped with a connected multi-function panel with a control interface to an electronic lock mechanism, a computing cloud, and a distributed software environment for administering and securely distributing digital access credentials to the door control assembly.

Once received the access credentials from the software in the cloud computing, the multi-function panel releases the electronic door lock mechanism to allow access to the facility only when the matching digital credentials, for instance a PIN or other identifying code, are entered in the multi-function panel and received by the facility's guests directly from the cloud computing through a variety of digital messaging systems.

### BACKGROUND OF THE INVENTION

### Field of the Invention

The present invention pertains to the art of access control systems, and more particularly to an automatic door lock mechanism in a housing facility with digital credentials to access the facility provisioned and managed as a software task in a cloud-computing environment and directly communicated to facility guests' mobile devices.

### Related Art

Most used existing access control systems in housing facilities:
1. door locks using programmable cardkey systems
2. door locks using mobile phone digital keys and a RF receivers for wireless technologies such as Bluetooth or NFC (Near Field Communication)

Limitations of 1): cardkeys are time consuming to program and always not recycled. The time needed to program a cardkey at an hotel check-in may create long waiting lines for arriving guests, up to 90 minutes average in large hotel resorts at peak times. The relatively high rate of loss cards, that is cards that are not returned, is an ongoing cost for the housing facility.

Limitations of 2): digital credentials are only valid when used with the mobile device they have been issued for; they cannot be transferred to other devices making it difficult for other guests to share the same room. The room cannot be accessed if the mobile device has no battery charge or has been left inside the room to recharge or otherwise not in physical possession of the person using the facility. Use of 2) is also limited to owners of more modern mobile devices that have the RF technology needed to communicate with the electronic lock.

### SUMMARY OF THE INVENTION

The present invention is directed to a cloud-based keyless access control system and method of use, which overcome the above-mentioned limitations and provides several additional advantages such as:
direct-to-room guest experience eliminating check-in waiting lines at the registration desk
service personnel to use the multi-function panel to signal that a room is ready with immediate notification to guests of room's availability
tracking in the cloud of rooms access, both successful and non successful doors unlocking attempts are tracked in real-time
guest to change credentials to PIN at the multi-functional panel
guest picture taken with the panel's built-in camera after entering the PIN, subsequently uploaded to the cloud
mic/speaker as interphone
guest identification by ID scan at the panel, ID scan stored in the cloud
physical tampering attempts to handle the multi-function panel are detected and communicated to the computing cloud by the multi-function panel

The present invention resides in a door control assembly and an access control software method executed in a computing cloud environment and interfacing with a multi-function panel in the door control assembly equipped with a network communication interface. A door control constructed in accordance with the present invention includes a multi-function panel with a touch panel and a display, equipped with a network interface such as Wi-Fi (IEEE 802.11), GSM/UMTS/LTE carrier networks, or Ethernet (IEEE 802.3), and firmware in such unit that allows secure communication with the cloud computing software for sending guests panel usage data, and for receiving digital credentials to allow access to the room such as PIN (Personal Identification Number) or other identifying code.

The door control assembly includes an electronic lock that releases the latch or bolt locking the door under control of an actuator in an included control board. The electronic lock is installed inside the room and protected from access, while the multi-function panel is installed outside the room for instance mounted on the wall near the door. To unlock the door and access the room, guests need to enter the proper PIN or other unique identifying code on the touch screen of the multi-function panel, which upon match with the code received from the computing cloud, communicates securely with a control board in the electronic lock assembly that energizes the actuator to release the latch or door lock in the electronic lock assembly.

Key to insure security and control access only to authorized guests in their assigned rooms, is the ability of the access control software in the computing cloud to acquire rooms occupancy data from either its own the back-office user interface, or by interacting with an external property management system software, and to revoke existing credentials on the multi-function panels at the time of guests check-out while setting new credentials into the multi-function panel of the room assigned to an arriving guest, and prior to his/her arrival. In one embodiment of the present invention, the digital credentials are encrypted and stored in the multi-function panel. In another embodiment, upon guests entering their PIN or other identifying code using the touch screen, the multi-function panel interacts with the access control software in the computing cloud to verify a match and allow access to the room after receiving a confirmation from the software method running in the computing cloud.

The access control software in the computing cloud provides also additional functions, and a browser user interface for authorized hotel back-office personnel to obtain certain information relevant to room access control. In one embodiment, the multi-function panel at the door sends a message to the access control software every time a door access is attempted, with the PIN entered, a matching result, and a timestamp. The access control software keeps tracks in its data storage of each message received from the multi-panels and provides an audit trail as part of the user interface. In another embodiment, the multi-function panel captures an image from its own camera at the time the PIN is entered, and sends the digital image to the access control software together in the message sent to track access attempts.

With respect to physical security of the proposed invention, only the multi-function panel and the serial cable connecting to the control board in the electronic lock assembly are exposed to the outside of the room. The actuators in the control board of the electronic lock assembly is under exclusive control of the control board which is itself equipped with a programmable CPU and firmware. In one embodiment of the present invention, the protocol of the multi-function panel with the control board is encrypted and it performs mutual authentication of the board and the panel before exchanging any data. The communication interface is shut down by the control board firmware upon detection of any tampering attempt for instance by not presenting the proper authentication credentials in the form of a X.509 digital certificate.

Other embodiments, aspects, and advantages of the present invention will become apparent from the following descriptions and accompanying drawings.

### BRIEF DESCRIPTION OF THE DRAWINGS

For a more complete understanding of the present invention and for further features and advantages, reference is now made to the following description taken in conjunction with the accompanying drawings, in which:

FIG. 1 is a block diagram of an exemplary cloud-based keyless access control system for housing facilities, according to one embodiment of the present invention; and

FIG. 2 is a block diagram of an exemplary door control with a cloud-based access control method, according to some embodiments of the present invention.

### DETAILED DESCRIPTION OF THE INVENTION

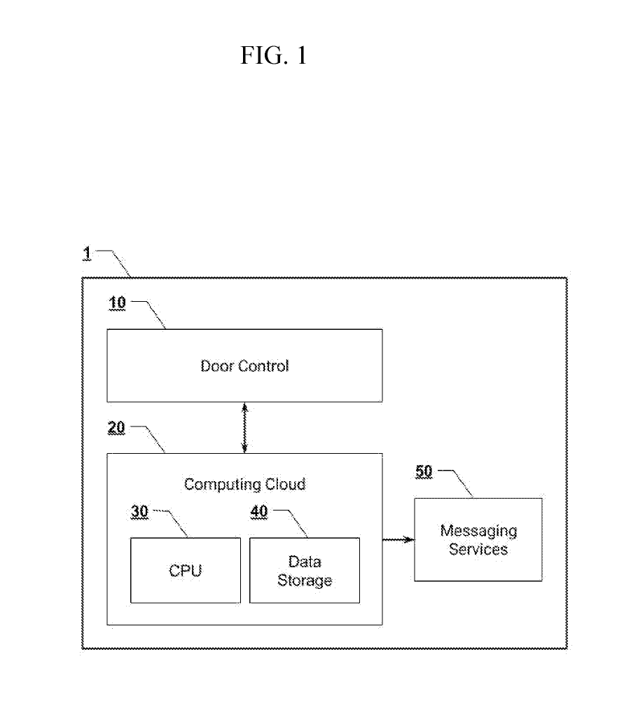

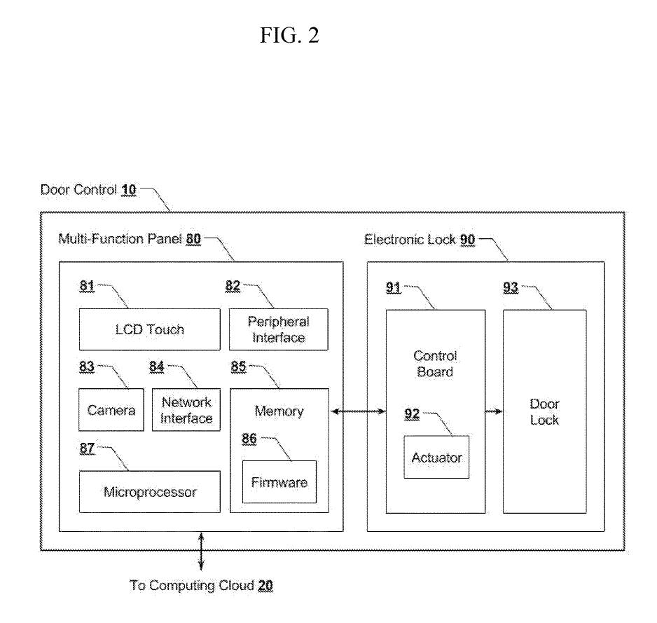

The preferred embodiments of the present invention and their advantages are best understood by referring to FIGS. 1 through 2 of the drawings provided below.

### System Architecture

FIG. 1 is a block diagram of an exemplary cloud-based, keyless access control for doors 1 according to this disclosure. In this diagram, one or more door control assemblies 10 are connected to an access control software computing cloud 20.

One innovative aspect of this disclosure is the ability to deploy software in the computing cloud to generate and remotely change the access credentials of a door control assembly, and at the same time to communicate the access credentials to a guest using third-parties, cloud-based electronic messaging services, including electronic mail, SMS and push messages to mobile devices. The control software executing in CPU 30 acquires guests' data for different rooms from manual input on its own browser user interface, a file uploaded from the same user interface, or communicating with an external property management system software. At the established check-in time, or by means of other notification, the access control software generates the access credential for the assigned rooms (PIN) and sends the proper command with the credentials to the door controls 10 to allow access to the guest presenting the proper credential as needed.

In some embodiments of this disclosure, one access control software task executed in the computing cloud's CPU 30, with its own private execution and data context, is instantiated in the computing cloud for each controlled facility comprising one or more door controls 10 to perform the access control of only those door control assemblies.

The computing cloud 20 is accessible from remote locations and includes at least one processing unit 30 and at least one data storage unit 40. The computing cloud 20 is capable of both storing information in data storage 40 and performing data functions of information in CPU 30, as well as to interact with external services such as a messaging service or a property management system, and with authorized end-users in the facility through a browser-based user interface.

The door control assembly 10 communicates with the access control software in a computing cloud 20 using any secured or unsecured protocol, such as the Transport Layer Security (TLS) or any other socket-based communication protocol. The communication between the door control assembly 10 and the computing cloud 20 is “bidirectional”, that is data is sent and received by both ends. In one embodiment, the multi-function panel 80 in the door control assembly 10, establishes a secure, permanent connection with the access control software in the computing cloud 20, to exchange messages with the access control software.

In some embodiments, the cloud computing 20 may store the credentials of all door controls for a managed facility to perform auditing and monitoring functions of all tempted and successful door accesses, including logging of credential used in all door control assemblies and time of use.

In some embodiments, the access control software method may leverage the service-oriented architecture of the cloud computing 20 to use third party services 50 to communicate the access credentials (PIN) for their assigned rooms to guests before their arrival in the facility, as well as to inform them with real-time information about room's availability, for instance by using a message received from the door control assembly activated by the service personnel once a room is clean and ready for occupancy by a new guest.

The access control software provides also at any given time, a real-time and continuously updated view of the guest occupancy and arrival status for each room in the facility, as well as the PIN credentials for each room to allow authorized personnel access to the room.

### Door Control

Door control 10 is the equipment to provide rom physical access control with a credential delivery method and access auditing in the access control software in the computing cloud 20.

FIG. 2 is the block diagram of an exemplary door control with a cloud-based access control method, according to some embodiments of the present invention. Door control 10 includes a multi-function panel 80 installed on the wall outside the room, and an electronic lock assembly 90 installed inside the room and in the door or door's frame, connected to the multi-function panel through a wired digital interface and cables. The multi-function panel includes a microprocessor 87 capable of executing firmware 86 stored in memory 85, an interface circuit 82 used to connect to electronic lock 90 and control board 91, and a network interface 84 used to connect to cloud computing 20. The control board 91 and actuator 92 set the state of the relay that control whether locking or latching mechanism in door lock 93 is released to allow the door to open or not. The control board 91 receives request to change door lock state only from the firmware of the multi-function panel 80 through a digital interface, for instance USB. The control board 91 is equipped with a programmable CPU and firmware to protect access and insure that door opening requests are received only from an authorized multi-function tablet.

Multi-function panel firmware 86 incorporates at least functions that acquire credentials from guests using the LCD touch panel 81 and determines whether to grant access based on matching credentials received from the access control software in the cloud computing 20 and stored in memory 85. When guest access is granted, firmware 86 communicates securely with electronic lock 90 and control board 91 to change state of actuator 92 and to release the lock or latch mechanism in door lock 93 that allows the door to open.

The multi-function firmware 86 allows to exchange messages with a software task executed remotely in the access control software in the cloud computing 20 for instance, to change the access credentials stored in memory 85, and for access control software to receive notification and track, relevant events detected or by result of guest and service personnel actions performed in the multi-function panel, such as a guest entering entry access credentials or service personnel notifying of room clean status and availability.

Other functions of the multi-function panel firmware 86 include protocol and encryption methods to enable a bi-directional, permanent secure communication with the access control software in the cloud computing 20, such as the Transport Layer Security (TLS) protocol, and protocol and encryption methods to enable secure communication with electronic lock 90 through the digital peripheral interface 82.

Multi-function panel memory 85 stores the firmware 86, the access credentials (PIN) that allow a guest to enter the room, and it may store other configuration data that allow the multi-function network interface 84 to connect to gateways or access points in the access network used by the multi-function panel to connect to cloud computing 20.

In some embodiment, a guest can use the multi-function panel 80 and LCD touch panel, to change the credentials (PIN) used to access the room. Such event is also propagated to the access control software in the computing cloud 20 by means of a message sent with the new credential information by the multi-function panel 80.

### HOAU Access Guest Workflow

Application is the HOAU Access Control Software in the cloud.

Guest data include:
1. Guest's first and last name
2. Guest's email address
3. Guest's mobile phone number
4. Assigned room number
5. Day of arrival
6. Day of departure
7. Time of room availability at arrival
8. Last time of checkout at departure

A Guest is in one of the following states: Arriving, Occupying and Staying.
1. Guest's state is Arriving after its booking data are entered into the Application in one of the following ways:
   a. Entering data manually from the Application browser front-end
   b. From a file uploaded manually from the Application browser front-end
   c. From a Property Management System automatically using the PMS API
2. Guest state becomes Occupying in one of the following ways:
   a. Automatically at the day and time of arrival
   b. When the Application receives a “Room Ready” message from the assigned room's tablet
   c. By manual operation from the Application browser front-end
   d. From a Property Management System automatically using the PMS API
3. Guest state becomes Staying in one of the following ways:
   a. Upon entering a correct PIN at the assigned room's tablet
4. Guest is removed by the Application in one of the following ways:
   a. Automatically at the day and time of departure
   b. By manual operation from the Application browser front-end
   c. From a Property Management System automatically using the PMS API

### PIN Lifecycle:

A PIN is generated by the Application for the Guest to access the assigned room when its state is Arriving.

The assigned PIN is activated on the room's tablet by the Application when the Guest's state is Occupying.

A PIN is revoked from the room's tablet by the Application when the Guest is removed.

### Messages:

A guest receives a message on Email and SMS indicating the assigned room number and the PIN at the time its state is Arriving.

Another message indicating room availability is sent in case the Guest's state is changed in Occupying by the Application upon receiving a “Room Ready” message.

We claim:

1. A cloud based keyless access control system for one or more door control assemblies comprising:
a. an automatic door lock mechanism comprising:
i. a door;
ii. an electric strike lock;
iii. an actuator;
iv. a control board with programmable CPU to operate the actuator; and
v. a serial USB cable wherein the control board is under exclusive control of an associated multi function panel;
b. a multi-function panel with a touch screen wherein digital credentials of a guest are encrypted and stored, the multi-function panel comprising:
i. firmware;
ii. a LCD touch screen panel;
iii. a camera;
iv. a microphone;
v. a speaker;
vi. a network interface to communicate with a computing cloud;
vii. a USB peripheral interface to connect to the control board of an automatic door lock mechanism;
viii. a microprocessor;
ix. memory that stores the firmware;
x. a plurality of sensors configured to acquire guest biometric information and sensor data from the camera; and
xi. a touch screen panel to acquire numeric guest credentials,
wherein the multi-function panel and USB cable connecting to the control board in the electronic lock assembly are exposed outside of the door;
c. a computing cloud comprising access control software that can generate, store, and change access credentials of a guest and occupancy data of a given door assembly and exchanged with the associated multi-function panel comprising:
i. at least one CPU;
ii. a server to store guest data; and
iii. at least one data storage unit; and
d. a property management system in communication with the computing cloud comprising:
i. an access network having one or more gateways; and
ii. one or more access points.

2. The system of claim 1, wherein the computing access control software further comprises a data storage server configured for storage, generation, usage tracking, and revocation of biometric data and digital credentials.

3. The system of claim 2, wherein the sensor biometric data consists of PIN codes, biometric data gathered by digital photos taken from the multi-function panel at door unlocking attempts, and driver license scan information.

4. The system of claim 1, wherein the access control software task executed remotely in the computing cloud can change access credentials stored in memory, generate, and send notifications and responses between property management server and registered guest.

5. The system of claim 1, wherein the access control software is in bidirectional communication with a secure property management system and an automatic door lock mechanism.

6. The system of claim 1, wherein the access control software can change access credentials stored in the multi-function panel memory, generate and send notifications, advertisements, and responses between said access control software and guest.

7. The system of claim 1, further comprising a tertiary server that can revoke existing digital credentials and set new credentials to be stored on the multi-function panel.

8. The system of claim 1, wherein the property management system can relay information to the computing cloud relating to the one or more door assemblies, the information including room occupancy, door number, guest bookings, arrival dates and times, departure dates and times, and hotel check-ins.

9. The system of claim 1, wherein the multi-function panel can relay information consisting of guest state, guest actions on the multi-function panel, and lock state to the access control software.

10. A method of controlling access to a plurality of doors by a plurality of door users, via an electronic identification authentication process comprising the steps of:
a. collecting a user's personal data consisting of name, email address, phone number, room number, arrival date, arrival time, departure date, departure time, time of room availability at arrival and last time of checkout at departure;
b. storing user's personal data in the access control software;
c. registering a user into the access control software, wherein the registered user is guest, wherein the guest is further accorded a status state selected from the group consisting of arriving, occupying, or staying; and
d. providing a registered user with a status state and an access PIN.

11. A method for managing and monitoring an automated door controlled assembly that allows access to a room, said access controlled by an electric strike or automatic lock mechanism using a PIN based access code, the method comprising:
a. a multi-function panel receiving guest data and reservation data from a property management system or receiving said guest data from a guest, wherein said personal data comprises a guest profile and booking information;
b. an access control software server receiving input from a property management system comprising guest profile and booking information;
c. a comparison module comparing the guest profile data credentials with the guest data stored in access control software and the multi-function panel against the input communicated to the multi-function control panel;
d. communicating via public key infrastructure a request from the property management system to access control software executed in a computing cloud to a property management system;
e. communicating a guest state is arriving and access credentials (PIN) via public key infrastructure a request from the access control software to the multi-function panel associated with the door of the room selected or assigned;
f. verifying, at the multi-function panel, that the guest input PIN matches the PIN within the multi-function panel or stored in access control software cloud storage;
g. verifying, at the multi-function panel, door control number and reservation credentials match those within the access control software; and
h. energizing the electric strike lock of said door to allow for access to a guest.

12. The system of claim 10, wherein the access control software communicates guest status with the firmware in the multi-function panel to store the digital credentials and access PIN used to communicate with the control board to energize the electric strike to open a door.

13. The method of claim 10, wherein the access information is retrieved by the access control software in the computing cloud using a communications means selected from a group comprising GSM/UMTS/LTE carrier networks, Ethernet, or IEEE 802.11.

14. The method of claim 10, wherein all communication between the multi-function panel, access control software, and property management is encrypted via use of PKI standards and protocols.

15. The system of claim 1, wherein the multi-function panel captures a picture or a video of the user attempting to open a door control assembly each time an access attempt is made, and said picture or video is uploaded to the access control software in the computing cloud, wherein a log of access attempts is created in the access control software in the computing cloud.

16. A method of controlling access to a plurality of doors by a plurality of door users via a communications network, the method comprising the steps of:
a. storing and managing a guest state for each of the doors in an access control server;
b. generating and storing a unique key signature for each of the users in the access control server;
c. assigning and communicating to the multi-function panel of each door assembly the unique key signature having access authorization to the respective doors;
d. comparing a user's digital credential input (PIN), at a door assembly multi-function panel to the digital credentials (PIN) stored in the multi-function panel itself or in the access control software and providing access authorization to the door;
e. retrieving a guest state from the access control server wherein if guest state is either occupying or staying;
f. the multi-function panel communicating a signal to the door control assembly control board authorizing access to the door,
wherein if guest state is arriving, the access control server communicates a signal to property management system to cross check guest data with digital credentials received at multi-function panel,
wherein the authorization step is carried out through a secure encrypted communication between the multi-function panel and the door assembly control board, and each user can gain access to the doors authorized to the user with a unique PIN and each door can provide access to the user or users assigned thereto, and
wherein upon completion of the authorization step, the multi-function panel communicates a signal to the door control assembly control board to energize the electric strike into an open state.

17. A method to allow automatic access by a user to a pre-reserved hotel room, the method comprising:
a. receiving, at a central property management reservation system, a request from a portable electronic device that includes user data and location data, wherein the location data indicates a hotel name and hotel room number associated with the pre-reserved hotel room, and the location data is determined from a label including a code associated with the pre-reserved hotel room that identifies the hotel name and the hotel room number associated with the pre-reserved hotel room;
b. querying a guest profile database based stored within a network server comprising access control software to determine a guest identification;
c. communicating a room opening request from the multi-function panel to the access control software corresponding to the pre-reserved room, the room opening request including the guest identification, digital credentials captured at the time of attempted entry, the reservation number, the hotel name, and the hotel room number;
d. verifying, at the access control software server, that the guest identification, the reservation number, the hotel name, and the hotel room number match a reservation associated with the pre-reserved hotel room stored in the property management server; and
e. the multi-function panel software sending an encrypted signal to the door assembly control board causing the electric strike to be opened to allow access by the user in response to the guest identification, the reservation number, the hotel name, and the hotel room number matching the reservation associated with the pre-reserved hotel room.
